(19) United States
(12) Patent Application Publication
(10) Pub. No.: US 2009/0235277 A1
(43) Pub. Date: Sep. 17, 2009

(54) Device Proxy Method and Related Apparatus for a Universal Plug and Play Network System

(76) Inventor: Chia-Chieh Liu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/181,323

(22) Filed: Jul. 29, 2008

(30) Foreign Application Priority Data
Mar. 11, 2008 (TW) 097108501

(51) Int. Cl. G06F 9/54

(52) U.S. Cl. 719/313

(57) ABSTRACT

To eliminate inconvenience of manual setup for a device without a universal plug and play (UPnP) function, the present invention provides a proxy method for automatically introducing a non-UPnP device into a UPnP network system including a control point. The non-UPnP device includes media information and a plurality of services corresponding to the media information. The device proxy method includes providing the media information for the control point to set up a communication with the control point, receiving a control message generated according to the media information from the control point, outputting a control indication to the non-UPnP device according to the control message, receiving a confirming indication from the non-UPnP device, and outputting a response message conforming to the UPnP protocol to the control point according to the response indicator.

### BACKGROUND OF THE INVENTION

1. Field of the Invention

The present invention relates to a proxy method and related apparatus, and more particularly to a device proxy method and related apparatus for a universal plug and play network system.

2. Description of the Prior Art

Universal Plug and Play (UPnP) is a network protocol allowing a UPnP device to be automatically discovered when physically connecting to a host device and automatically enable communication with the host without user manual configuration, such as manual address configuring. The physical connection can be achieved via wired or wireless transmission protocol, such as Universal Serial Bus (USB), Bluetooth or a peripheral component interconnect express (PCI Express) protocol IEEE 1394.

The UPnP network system is set up on the basis of Internet Protocol (IP), Transmission Control Protocol (TCP), User Datagram Protocol (UDP), Hypertext Transfer Protocol (HTTP), Extensible Markup Language (XML) and other involved network technologies. Typical architecture of the UPnP network system includes three types of fundamental members: UPnP devices, Services and Control Points. In addition, a UPnP device is used for realizing the services and can include a number of embedded devices, whereas a control point is responsible for discovering and controlling the UPnP device to execute the services.

To achieve UPnP networking, the six stages are provided in the communications protocol between the UPnP device and the control point as follows:

1. Addressing: The UPnP device obtains an IP address assigned by a DHCP (Dynamic Host Configuration Protocol) server or uses Auto IP to get an address if no DHCP server is available.

2. Discovery: The UPnP device, physically added to the network, multicasts a number of discovery messages according to SSDP (Simple Service Discovery Protocol) to advertise its services to the control points. When a control point is added to the network, the control point searches for a UPnP device. The discovery stage provides a little device and service information about the UPnP device and its capabilities, such as a UPnP type or an universally-unique identifier.

3. Description: After the discovery stage, the control point still knows insufficiently about the UPnP device. To learn more about the capabilities of the UPnP device, the control point retrieves a description message of the UPnP device according to a uniform resource locator (URL) included in the discovery message. The description message is formed in XML format and records device brand information, manufacturing information including a type name or a type assigned number, a serial number, and a manufacture name, and URLs related to available services. In addition, the description message can include an embedded device list, a service list and associated URLs for the next two stages. For each kind of device, the description message describes commands and an action list for different services.

4. Control: The control point can start to send an actions request to the UPnP device for service execution. First, the control point delivers a control message to the related control URL and thereby the UPnP device executes the corresponding service. The control message is described based on a simple object access protocol (SOAP). Furthermore, the UPnP device returns a resulting value to notify of the service state, such as an executing error.

5. Eventing: The UPnP device updates service variables as long as the service state is changed, and the updated service variables are sent to the control point via an eventing message.

6. Presentation: The UPnP device provides a presenting URL to the control point to allow a user to control or view the UPnP device state via a browser loading the presenting URL.

Take a router equipped with the UPnP function for example. When the router is coupled to the computer host via a networking wire, a computer host performs from the stage 1 to 5 to automatically detect and add to the router. In addition, the computer host can acquire a web page by a URL given the router. From the web pages, the user can obtain the router state and configures related functions, such as functions to enable or disable a network port or to set a local area network (LAN) address.

However, a number of computer peripheral devices are still equipped with no UPnP function, known as non-UPnP devices. The user needs to manually install the non-UPnP devices into the UPnP network system. Manual installation is burdensome to users.

### SUMMARY OF THE INVENTION

The present invention therefore provides a proxy method and related apparatus for representing a non-UPnP device attempting to participate in a UPnP network system.

The present invention discloses a proxy method for introducing a device equipped without functions configured based on a UPnP protocol, into a UPnP network system including a control point. The non-UPnP device includes media information and a plurality of services corresponding to the media information. The device proxy method includes providing the media information for the control point to establish a connection with the control point, receiving a control message for controlling a service of the plurality of services, the control message being generated by the control point according to the media information, outputting a control indication corresponding to the service to the non-UPnP device according to the control message, receiving a confirming indication generated by the non-UPnP device according to the control indication, and then outputting a response message conforming to the UPnP protocol to the control point according to the confirming indication.

The present invention further discloses a proxy device for introducing a device equipped without functions configured based on a UPnP protocol into a UPnP network system comprising a control point. The non-UPnP device includes media information and a plurality of services corresponding to the media information. The device proxy method includes a virtual unit and a transforming unit. The virtual unit is coupled to the control point and includes the media information. Further, the virtual unit is used for providing the media information for the control point to establish a connection with the control point and receiving a control message for controlling a service of the plurality of services. The control message is generated by the control point according to the media information. The transforming unit is coupled to the virtual unit and the non-UPnP device, and used for outputting a control indication corresponding to the service to the non-UPnP device according to the control message and outputting a response message conforming to the UPnP protocol to the control point according to a received confirming indication. The received confirming indication is generated by the non-UPnP device according to the control indication.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a proxy process according to an embodiment of the present invention.

FIG. 2 is a schematic diagram of a proxy device according to an embodiment of the present invention.

FIG. 3 is a schematic diagram of a UPnP network system.

### DETAILED DESCRIPTION

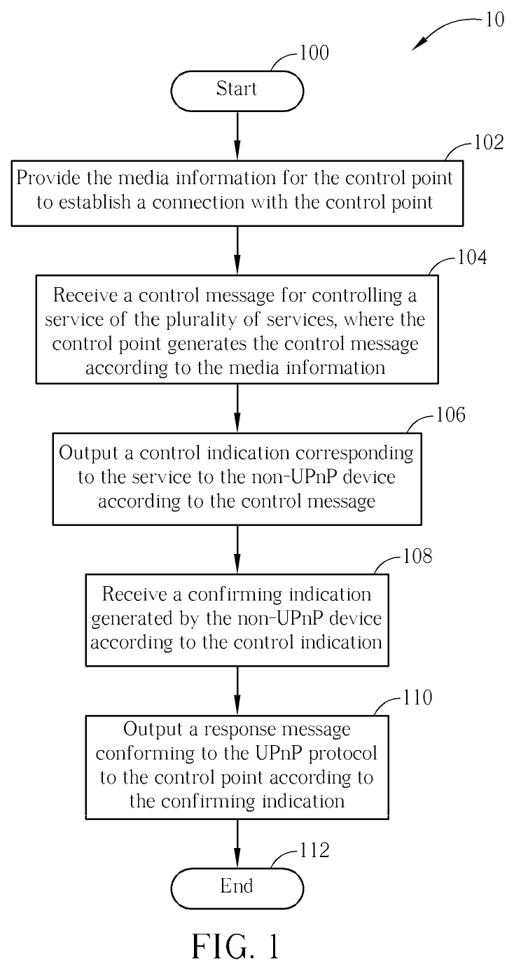

Please refer to FIG. 1, which is a schematic diagram of a proxy process 10 according to an embodiment of the present invention. The proxy process 10 is utilized for introducing a non-UPnP device into a UPnP network system. The non-UPnP device includes media information and a plurality of services corresponding to the media information, and the UPnP network system includes a control point and a proxy device, where the proxy device is utilized for realizing the proxy process 10 to achieve communication between the non-UPnP device and the control point. The proxy process 10 includes the following steps:

Step 100: Start.

Step 102: Provide the media information for the control point to establish a connection with the control point.

Step 104: Receive a control message for controlling a service of the plurality of services, where the control point generates the control message according to the media information.

Step 106: Output a control indication corresponding to the service to the non-UPnP device according to the control message.

Step 108: Receive a confirming indication generated by the non-UPnP device according to the control indication.

Step 110: Output a response message conforming to the UPnP protocol to the control point according to the confirming indication.

Step 112: End.

According to the process 10, the embodiment of the present invention provides the media information of the non-UPnP device for the control point, and thereby the control point can discover the non-UPnP device and acquire related descriptions so as to control the non-UPnP device to execute services.

Preferably, the media information includes device and service information of the non-UPnP device. The device information is described with a device name, a device type, a device serial number, an indicator and URLs related to service and presentation, whereas the service information is described with service types, service URLs, commands and actions corresponding to the services. Furthermore, Step 102 is preferably regarded as the discovery and description stages of the foregoing UPnP communications protocol. When the non-UPnP is physically connected to the proxy device, the proxy device performs the discovery stage delivering a discover message based on the SSDP, so that the non-UPnP device can be registered to the control point. As can be known from the above, the discovery message includes little device and service information, usually only including the device type and identifier, the service type, and a URL. To learn more about the non-PnP device, the control point delivers a description request to the proxy device according to the URL included in the discovery message after the discovery message is received. The proxy device then performs the description stage for the non-UPnP device and thereby generates a description message for the control point after the description request is received. The description message includes the media information providing the control point with comprehensive information of the non-UPnP device. More specifically, the media information includes hardware information of the non-UPnP device (the root device) and embedded devices thereof, and types, command and action lists and URLs corresponding to each service of each device.

After having the media information of the non-UPnP device, the control point is allowed to deliver a control message for a specific service to the proxy device, so as to control the non-UPnP device through the proxy device. Preferably, the control message is described based on the SOAP.

Steps 104 to 110 are designed for controlling the non-UPnP device. The proxy device generates a first message with an application program interface (API) according to the control message, and then translates the first message into a control indication recognizable for the non-UPnP device. Preferably, the proxy device and the non-UPnP device adopt the hypertext transfer protocol (HTTP) as the communications protocol. In response to the control indication, the non-UPnP device returns a confirming indication to confirm executing state of the service or related actions. The proxy device translates the confirming indication into a response message conforming to the UPnP protocol and then outputs the response message to the control point. After the proxy process 10 is successfully completed, the control point can start to control the non-UPnP to execute services or actions through the proxy device.

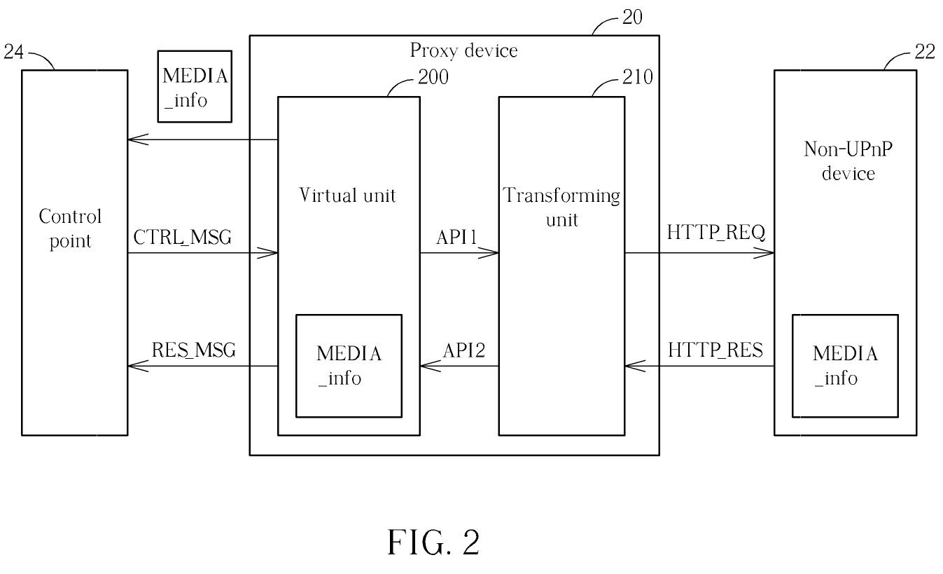

Please refer to FIG. 2, which is a schematic diagram of a proxy device 20 according to an embodiment of the present invention. The proxy device 20 can be used for realizing the proxy device 10 to introduce a non-UPnP device 22 into a UPnP network system including a control point 24. The non-UPnP device 22 includes media information MEDIA_info and a plurality of services corresponding to the media information MEDIA_info, and can couple to the proxy device 20 via wired or wireless communications protocols, such as USB, Bluetooth or the PCI Express protocol IEEE 1394. The proxy device 20 includes a virtual unit 200, as a virtual substitute of the non-UPnP device 22 from the standpoint of the control point 24, and a transforming unit 210 responsible for communicating with the non-UPnP device 22 based on HTTP. The virtual unit 200 naturally includes the media information MEDIA_info, and performs the discovery and description stages for the non-UPnP device 22. By communicating with the virtual unit 200, the control can obtain the media information MEDIA_info, and thereby the non-UPnP device 22 can be registered to the control point 24. During the control stage, the control point 24 generates a control message CTRL_MSG according to a specific service provided by the media information MEDIA_info. The virtual unit 200 generates a first message API1 with the API according to the control message CTRL_MSG and outputs the first message API1 to the transforming unit 210. The first message API1 is then translated into a control indication HTTP_REQ. In response to the control indication HTTP_REQ, the non-UPnP device 22 returns a confirming indication HTTP_RES to confirm the executing states of the service or associated actions. The transforming unit 210 translates the confirming indication HTTP_RES into a second message API2. Finally, the virtual unit 200 outputs a response message RES_MSG to the control point 24 according to the second message API2.

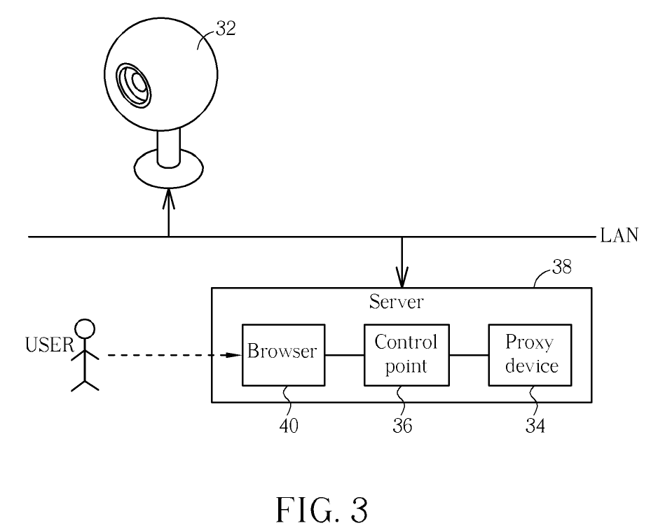

Please refer to FIG. 3, which is a schematic diagram of a UPnP network system 30 according to an embodiment of the present invention. The UPnP network system 30 includes a web camera 32, a proxy device 34, a control point 36 and a server 38. The web camera 32 is disabled from self-execution of UPnP functions, and coupled to a server 38 via a LAN. The proxy device 34 and the control point 36 are jointly installed in the server 38, and the control point 36 provides information of the web camera 32 for a user via a browser 40 set up in the server 38. To introduce the web camera 32 into the UPnP network system 30, the proxy device 34 plays a substitute device for the web camera 32 to perform the discovery, description and control stages with the control point 36.

During the discovery stage, the proxy device 34 spontaneously registers the web camera 32 to the control point 36 via the discover message including the network address and port of the control point 36, the simple description information of the web camera 32, a service type, an operating system information and so on. Progressing forward to the description stage, the control point 36 uses a description request to ask the proxy device 34 to provide the web camera 32 with comprehensive device and service information.

The proxy device 34 includes a presenting URL of the web camera 32, and the user can browse the web page on the browser 40 with the presenting URL so that the user can control operations of the web camera 32. During the control stage, to control the web camera 32 to execute the specific service, the control point 36 delivers a control message described with control URLs of the service, preferred language and related coding type, action types and variables associated with service state. The proxy device 34 translates the control message into an HTTP-based indication recognizable for the web camera 32. If the web camera 32 executes the service successfully or accepts the indication, the web camera 32 returns a confirming indication whose content is “200 ok”. In this situation, the proxy device 34 responds the control point 36 with a response message including preferred language and related coding type, actions and variables related to changed service states. If the web camera 32 fails to operate according to the indication content, the web camera 32 generates response messages with different contents according to error types. For example, a response message whose content is “611” indicates an invalid URL, and a “401” response message indicates an invalid instruction, and a “603” response message indicates insufficient memory.

In conclusion, the present invention provides a proxy substituting the non-UPnP device to perform UPnP communications with the control point. Therefore, the non-UPnP device can automatically be introduced into the UPnP network system, eliminating the inconvenient manual configuring.

Those skilled in the art will readily observe that numerous modifications and alterations of the device and method may be made while retaining the teachings of the invention.

What is claimed is:

1. A proxy method for introducing a device equipped without functions configured based on a Universal Plug and Play (UPnP) protocol, hereinafter called non-UPnP device, into a UPnP network system comprising a control point, the non-UPnP device comprising media information and a plurality of services corresponding to the media information, the device proxy method comprising:
providing the media information for the control point to establish a connection with the control point;
receiving a control message for controlling a service of the plurality of services, the control message being generated by the control point according to the media information;
outputting a control indication corresponding to the service to the non-UPnP device according to the control message;
receiving a confirming indication generated by the non-UPnP device according to the control indication; and
outputting a response message conforming to the UPnP protocol to the control point according to the confirming indication.

2. The proxy method of claim 1, wherein the media information comprises device information, comprising information about a device name, a device type and a device serial number, and service information comprising information about commands and actions corresponding to the service.

3. The proxy method of claim 1, wherein providing the media information for the control point to establish the connection with the control point comprises:
delivering a discovery message to register the UPnP device to the control point;
receiving a description request message generated by the control point according to the discovery message; and
in response to the description request message, outputting a description message comprising the media information to the control point.

4. The proxy method of claim 3, wherein the discovery message is delivered according to a simple service discovery protocol (SSDP).

5. The proxy method of claim 3, wherein the description message comprises a uniform resource locator (URL) corresponding to the service of the non-UPnP device.

6. The proxy method of claim 1, wherein outputting the control indication corresponding to the service to the non-UPnP device according to the control message comprises:
according to the control message, generating a first message with an application program interface (API); and
translating the first message to generate the control indication.

7. The proxy method of claim 1, wherein outputting the control indication to the UPnP device and receiving the confirming indication are outputting the control indication to the UPnP device and receiving the confirming indication according to a hypertext transfer protocol (HTTP).

8. A proxy device for introducing a device equipped without functions configured based on a Universal Plug and Play (UPnP) protocol, hereinafter called non-UPnP device, into a UPnP network system comprising a control point, the non-UPnP device comprising media information and a plurality of services corresponding to the media information, the device proxy method comprising:
a virtual unit coupled to the control point and comprising the media information, for providing the media information for the control point to establish a connection with the control point and receiving a control message for controlling a service of the plurality of services, the control message being generated by the control point according to the media information; and
a transforming unit coupled to the virtual unit and the non-UPnP device, for outputting a control indication corresponding to the service to the non-UPnP device according to the control message and outputting a response message conforming to the UPnP protocol to the control point according to a received confirming indication, the received confirming indication being generated by the non-UPnP device according to the control indication.

9. The proxy device of claim 8, wherein the media information comprises device information, comprising information about a device name, a device type and a device serial number, and service information comprising information about commands and actions corresponding to the service.

10. The proxy device of claim 8, wherein the virtual unit, for providing the media information for the control point to establish a connection with the control point, delivers a discovery message to register the UPnP device to the control point, receives a description request message generated by the control point according to the discovery message, and, in response to the description request message, outputs a description message comprising the media information to the control point.

11. The proxy device of claim 10, wherein the discovery message is delivered according to a simple service discovery protocol (SSDP).

12. The proxy device of claim 10, wherein the description message comprises a uniform resource locator (URL) corresponding to the service of the non-UPnP device.

13. The proxy device of claim 8, wherein the virtual unit comprises an internal relaying unit coupled to the transforming unit, for generating a first message with an application program interface (API) according to the control message.

14. The proxy device of claim 13, wherein the transforming unit translates the first message to generate the control indication corresponding to the service.

15. The proxy device of claim 8, wherein the transforming unit outputs the control indication to the UPnP device and receives the confirming indication according to a hypertext transfer protocol (HTTP).
